(19) United States
(12) Patent Application Publication
(10) Pub. No.: US 2025/0358872 A1
(43) Pub. Date: Nov. 20, 2025

(54) METHOD FOR AN ACCESS POINT TO PROVISION A WI-FI NETWORK, DEVICES OPERATING A WPA2-PERSONAL SECURITY PROTOCOL OR A WPA3-PERSONAL SECURITY PROTOCOL

(71) Applicant: HUAWEI TECHNOLOGIES CO., LTD., SHENZHEN (CN)

(72) Inventors: Michael MONTEMURRO, Kanata (CA); Stephen MCCANN, Kanata (CA)

(73) Assignee: HUAWEI TECHNOLOGIES CO., LTD., SHENZHEN (CN)

(21) Appl. No.: 19/280,860

(22) Filed: Jul. 25, 2025

Related U.S. Application Data
(63) Continuation of application No. PCT/CN2024/071680, filed on Jan. 10, 2024.
(60) Provisional application No. 63/449,786, filed on Mar. 3, 2023.

(51) Int. Cl. H04W 76/10; H04W 12/0431; H04W 12/08

(52) U.S. Cl. CPC H04W 76/10; H04W 12/0431; H04W 12/08

(57) ABSTRACT

A method for an access point (AP) to advertise that it supports Wi-Fi Easy Connect provisioning by broadcasting to devices, a frame that specifies the provisioning in question. The method includes, by the AP, receiving from a device, a frame indicating the device wishes to connect to the AP, and sending, by the AP, to the device a frame indicating the AP allows the device to connect to the AP. Subsequently, the AP and device follow the Wi-Fi Easy Connect protocol. Also provided is a method for an AP to advertise it supports a Wi-Fi Protect Setup (WPS) provisioning protocol and the Wi-Fi Easy Connect provisioning protocol to connect a device to the AP. The method includes, by the AP, broadcasting an AP frame structured to specify that the AP supports a Wi-Fi Protect Setup (WPS) provisioning protocol and a Wi-Fi Easy Connect provisioning protocol to connect a device to the AP; receiving, from a device that received the first AP frame, one of: a device frame structured to indicate that the device selects the WPS provisioning protocol to connect to the AP; and a device frame structured to indicate that the device selects the Wi-Fi Easy Connect provisioning protocol to connect to the AP. Further provided is an access point configured to perform the methods mentioned herein.

### CROSS-REFERENCE TO RELATED APPLICATIONS

This application is a continuation of International Application No. PCT/CN2024/071680, filed on Jan. 10, 2024, which claims the benefit of U.S. Provisional Application No. 63/449,786 titled “METHOD FOR AN ACCESS POINT TO PROVISION A WI-FI NETWORK, DEVICES OPERATING A WPA2-PERSONAL SECURITY PROTOCOL OR A WPA3-PERSONAL SECURITY PROTOCOL” filed Mar. 3, 2023, which is incorporated by reference herein in its entirety.

### FIELD OF THE INVENTION

The present invention pertains to the field of Wi-Fi networks, in particular to a method and apparatus for a user device to connect to a Wi-Fi network.

### BACKGROUND

The Wi-Fi Alliance promotes Wireless Local Area Network (WLAN) technology with a focus on interoperability between Wi-Fi devices and the security of Wi-Fi networks.

The original security protocol adopted for Wi-Fi networks was the Wired Equivalent Privacy (WEP) protocol, which aimed to provide data confidentiality similar to that offered by traditional wired networks. However, with time, faults were discovered and exploited, leading to the WEP protocol being superseded by the Wi-Fi Protected Access (WPA) protocol to address the WEP vulnerabilities. The WPA protocol continues to use versioning to improve security. Various versions of the WPA protocol include:
WPA—improved security over WEP based on a draft of IEEE 802.11i.
WPA2—security based on the published version of IEEE 802.11i.
WPA3—security based on further enhancements (e.g., Protected Management Frames, Galois/Counter Mode Protocol (GCMP), etc.) in IEEE 802.11 amendments, following IEEE 802.11i.

Similarly, the Wi-Fi Alliance has introduced network security standards to create and connect to Wi-Fi networks. Some of the network security standards include:
Wi-Fi Protected Setup (WPS) provisioning protocol; and
Wi-Fi Easy Connect provisioning protocol, which is also known as the Device Provisioning Protocol (DPP).

WPS defines how to connect Wi-Fi devices to Wi-Fi networks using the WPA2-Personal protocol (also known as WPA-PSK in IEEE 802.11). There are two main mechanisms provided for WPS for adding a new device to a Wi-Fi network. The mechanisms are:
Personal Identification Number (PIN) mechanism where a user is required to enter, at an access point (AP) of the Wi-Fi network, a PIN written on the new device. As an alternative, the user may be required to enter, at the new device, a PIN written on the AP; and
Push Button mechanism where a user needs to push a button on the access point device and push a button on the new device. The button may be an actual button or a virtual button.

### Wi-Fi Protected Setup

FIG. 1 shows a prior art process flow of WPS provisioning of an enrollee (a device, a station) to a Wi-Fi network.

A typical WPS use case is as follows:
A device discovers a Wi-Fi network to which they want to connect.
The user of the device pushes a button (or enters a PIN) on an AP-sometimes the PIN is provided.
The user of the device pushes a button or enters a PIN on the device.
The device and the AP discover each other, and then complete association to provision a pre-shared key (PSK) on the client device, as shown in FIG. 1. [EAP Extensible Authentication Protocol. EAPOL EAP over LAN.]

### Wi-Fi Simple Configuration

The Wi-Fi Simple Configuration (WSC) specification relates to the configuration of data exchanged during the setup and management of Wi-Fi networks. WSC encodes information as attributes in a binary type identifier, length and value (TLV) format. The WSC configuration records are in a TLV format that uses fields as defined in the TLV Format Table (Table 1). TLVs are transmitted and/or saved in big endian byte order.

TABLE 1

| Byte | Field | | |
|---|---|---|---|
| Offset | Length | Field Name | Description |
| 0 | 2 Bytes | Attribute Type | Type identifier for the attribute |
| 2 | 2 Bytes | DataLength | Length in bytes of the |
| | | | Attribute's data field |
| 4 | 0-0xFFFF | Data | Attribute data |
| | Bytes | | |

Most WSC attributes are simple data structures, but some are nested data structures that contain other TLV attributes. For example, the Encrypted Data attribute contains sub-attributes Key ID and Cyphertext. The cleartext (unencrypted) form of the Cyphertext Data field is itself a set of WSC attributes encoded in TLV format. The Credential attribute is another example of a compound attribute.

### Wi-Fi Easy Connect

FIG. 2 shows a prior art process flow of a Wi-Fi Easy Connect provisioning of an enrollee (a device, a station) to a Wi-Fi network.

Wi-Fi Easy Connect provides provisioning for WPA3 Personal networks. The Wi-Fi Alliance developed Wi-Fi Easy Connect as a new provisioning protocol to address security vulnerabilities in WPS and to address different provisioning scenarios for Internet of Things (IoT) devices.

In addition to newer security protocols such as WPA3 Personal, Wi-Fi Easy Connect can also provision devices using the WPA2 Personal (WPA-PSK) protocol. Wi-Fi Easy Connect mimics WPS by using:
A Public Key Exchange (PKEX)—i.e., a method that uses a passphrase which could be a PIN; or
A presence Button—a method based on PKEX which mimics a WPS Push Button as shown in FIG. 2.

This maintains the WPS user experience when connecting a device to a Wi-Fi network.

### Wi-Fi Provisioning Process

The generalized process for on-boarding (provisioning) a new device on a Wi-Fi network is:
Discover the network using the new device.
Perform an action on the AP (e.g., push a presence button or select a PIN).
Perform an action on the new device (e.g., push a presence button or enter a PIN).
The AP and new device perform a provisioning protocol.
The new device is provisioned and connects to the AP.

Customers are used to WPS mechanisms for adding a device to the network. However, WPS has security issues and does not support WPA3-Personal provisioning.

On the other hand, Wi-Fi Easy Connect is a new protocol that does support WPA3-Personal provisioning. However, there are situations where APs may be required to provide network access to newer devices supporting WPA3, as well as legacy devices that support WPA2.

Therefore, improvements in the art of providing a secure connection between a device and a Wi-Fi network are desirable.

This background information is provided to reveal information believed by the applicant to be of possible relevance to the present invention. No admission is necessarily intended, nor should be construed, that any of the preceding information constitutes prior art against the present invention.

### SUMMARY

In a first aspect, the present disclosure provides a method, that comprises, by an access point (AP) of a Wi-Fi network: broadcasting a first AP frame structured to specify that the AP supports a Wi-Fi Easy Connect provisioning protocol to connect a device to the AP; and receiving, from a device that received the first AP frame, a device frame structured to indicate that the device wishes to connect to the AP. The method further comprises, in response to having received the device frame, sending, to the device, a second AP frame structured to indicate that the AP will allow the device to connect to the AP; and interacting with the device to connect the device to the AP using the Wi-Fi Easy connect provisioning protocol.

In some embodiments, the device frame is a unicast device push button announcement frame, the second AP frame is a unicast AP push button announcement frame, and interacting with the device to connect the device to the AP using the Wi-Fi Easy connect provisioning protocol includes, by the AP: sending to the device, a unicast AP PKEX Exchange Request frame; and receiving, from the device, a unicast device PKEX Exchange Request frame.

The first AP frame may be a Beacon frame or a Probe Response frame. The device frame may be a device push button announcement frame. The second AP frame may be an AP push button presence announcement frame. The device frame may be a device Public Key Exchange (PKEX) Request frame. The second AP frame may be an AP PKEX Response frame.

In some embodiments, the AP has an operating channel. The device frame may be received over the operating channel; and the first AP frame and the second AP frame may be sent over the operating channel.

The device frame may comprise a device unicast message; and the second AP frame may also comprise an AP unicast message.

The first AP frame may include a Wi-Fi Simple Configuration (WSC) information element (IE) that specifies that the AP supports the Wi-Fi Easy Connect provisioning protocol to connect the device to the AP. The WSC IE may include an attribute that has a type field, a length field and a provisioning method field that specify if the Wi-Fi Easy Connect provisioning protocol follows a push button method or a PIN/PKEX method. The provisioning method field may have a value that is equal to either one or zero, the value zero to indicate one of the push-button method and the PIN/PKEX method, and the value one to indicate the other of the push-button method and the PIN/PKEX method.

The first AP frame may include a Wi-Fi Easy Connect information element (IE), distinct from any Wi-Fi Simple Configuration (WSC) information element (IE) that specifies that the AP supports the Wi-Fi Easy Connect provisioning protocol to connect the device to the AP.

The Wi-Fi Easy Connect IE may include an identification field, a length field, an Organizational Unique Identifier field, a type field, and a provisioning method field. The provisioning method field may have a value that is equal to either one or zero, the value zero to indicate one of the push-button method and the PIN/PKEX method, the value one to indicate the other of the push-button method and the PIN/PKEX method.

In another aspect, the present disclosure provides a method that comprises, by an access point (AP) of a Wi-Fi network: broadcasting an AP frame structured to specify that the AP supports a Wi-Fi Protect Setup (WPS) provisioning protocol and a Wi-Fi Easy Connect provisioning protocol to connect a device to the AP; and receiving, from a device that received the first AP frame, one of: a device frame structured to indicate that the device selects the WPS provisioning protocol to connect to the AP; and a device frame structured to indicate that the device selects the Wi-Fi Easy Connect provisioning protocol to connect to the AP.

The WPS provisioning protocol may be for selection by devices configured to support a single security protocol, wherein the single security protocol may be a WPA2-Personal security protocol. The Wi-Fi Easy Connect provisioning protocol may be for selection by devices configured to support a WPA3-Personal security protocol.

The AP frame may be a Beacon frame or a Probe Response frame. The AP frame may include at least one of: a Wi-Fi Simple Connection (WSC) information element (IE) that specifies that the AP supports the WPS provisioning protocol and the Wi-Fi Easy Connect provisioning protocol to connect the device to the AP; and a Wi-Fi Alliance vendor specific (WFAVS) IE that specifies the AP supports the WPS provisioning protocol and the Wi-Fi Easy Connect provisioning protocol to connect the device to the AP.

The device frame structured to indicate that the device selects the WPS provisioning protocol to connect to the AP may an Association Request frame; and the device frame structured to indicate that the device selects the Wi-Fi Easy Connect provisioning protocol to connect to the AP may be one of a Push Button Announcement frame and a PKEX Request frame.

The method may further comprise, by the AP: generating the AP frame in accordance with a Push Button signal generated by the AP, the AP frame configured to indicate that the AP frame was generated in accordance with the Push Button signal. The method may additionally comprise simultaneously listening for reception, from the device that received the AP frame, of one of: the Association Request frame; or the Push Button Announcement frame; and receiving from the device that received the AP frame, one of the Association Request frame and the Push Button Announcement frame.

When the AP receives the Association Request frame, the method may further comprise, by the AP: ending listening for reception, from the device that received the AP frame, of the Association Request frame or the Push Button Announcement frame; and provisioning the device to the AP in accordance with the WPS provisioning protocol and the WPA2-Personal security protocol.

When the AP receives the Push Button Announcement frame, the method may further comprise, by the AP: ending listening for reception, from the device that received the AP frame, of the Association Request frame or the Push Button Announcement frame; and provisioning the device to the AP in accordance with the Wi-Fi Easy Connect provisioning protocol and the WPA3-Personal security protocol.

The method may further comprise, by the AP: generating the AP frame in accordance with a PIN entry signal generated by the AP, the AP frame configured to indicate that the AP frame was generated in accordance with the PIN entry signal; listening for reception, from the device that received the AP frame, of one of: the Association Request frame; or the PKEX Request frame; and receiving from the device that received the AP frame, one of the Association Request frame and the PKEX Exchange Request frame.

When the AP receives the Association Request frame, the method may further comprise, by the AP: ending listening for reception, from the device that received the AP frame, of the Association Request frame or the PKEX Exchange Request frame; proceeding to provision the device to the AP in accordance with WPS provisioning protocol and the WPA2-Personal security protocol.

When the AP receives the PKEX Exchange Request frame, the method may further comprise, by the AP: ending listening for reception, from the device that received the AP frame, of the Association Request frame or the PKEX Exchange Request frame; proceeding to provision the device to the AP in accordance with the Wi-Fi Easy Connect provisioning protocol and the WPA3-Personal security protocol.

The method may further comprise, by the AP: receiving, from the device, prior to provisioning the device to the AP using the Wi-Fi Easy Connect provisioning protocol and the WPA3-Personal security protocol, a first IEEE 802.11 Authentication frame using the Pre-Association Security Negotiation (PASN) algorithm with the transaction sequence set to 1; sending, to the device, a second IEEE 802.11 Authentication frame using the PASN algorithm with the transaction sequence number set to 2; and receiving, from the device, a third IEEE 802.11 Authentication frame using the PASN algorithm with the transaction sequence number set to 3.

In another aspect, the present disclosure provides a method that comprises, by a device, receiving, from an access point AP, an announcement indicating that the AP supports a Wi-Fi Protect Setup (WPS) provisioning protocol and a Wi-Fi Easy Connect provisioning protocol to connect the device to the AP. When the device is configured to support the WPA3-Personal security protocol, the method comprises selecting the Wi-Fi Easy Connect provisioning protocol. When the device is configured to support the WPA2-Personal security protocol but not the Wi-Fi Easy Connect provisioning protocol, the method comprises selecting the WPS provisioning protocol.

In another aspect, the present disclosure provides a Wi-Fi network AP that comprises: a processor; and a tangible, non-transitory processor-readable memory having recorded thereon instructions to be performed by the processor to carry out a method as defined in any one of the methods described in the present disclosure.

Embodiments have been described above in conjunctions with aspects of the present invention upon which they can be implemented. Those skilled in the art will appreciate that embodiments may be implemented in conjunction with the aspect with which they are described but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present invention will become apparent from the following detailed description, taken in combination with the appended drawings, in which:

FIG. 1 shows a process flow of a prior art push button configuration-based connection of an enrollee to an AP using a WPS connection protocol.

FIG. 2 shows a process flow of a prior art push button configuration-based connection of an enrollee to an AP using a Wi-Fi Easy Connect connection protocol.

FIG. 3 shows an embodiment of a process flow for provisioning a device to a Wi-Fi network, through an access point, using the Wi-Fi Easy Connect provisioning protocol, in accordance with the present disclosure.

FIG. 4 shows another embodiment of a process flow for provisioning a device to a Wi-Fi network, through an access point, using the Wi-Fi Easy Connect provisioning protocol, in accordance with the present disclosure.

FIG. 5 shows a block diagram representation of Wi-Fi Simple Configuration information element in accordance with the present disclosure.

FIG. 6 shows an embodiment of a Wi-Fi Alliance vendor specific information element to advertise the Wi-Fi Easy Connect provisioning protocol, in accordance with the present disclosure.

FIG. 7 shows a further process flow for provisioning a device to a Wi-Fi network, through an AP, in accordance with the present disclosure.

FIG. 8 shows an additional embodiment of a process flow for provisioning a device to a Wi-Fi network, through an AP, in accordance with the present disclosure.

FIG. 9 shows a block diagram of an embodiment of an electronic device, in accordance with the present disclosure.

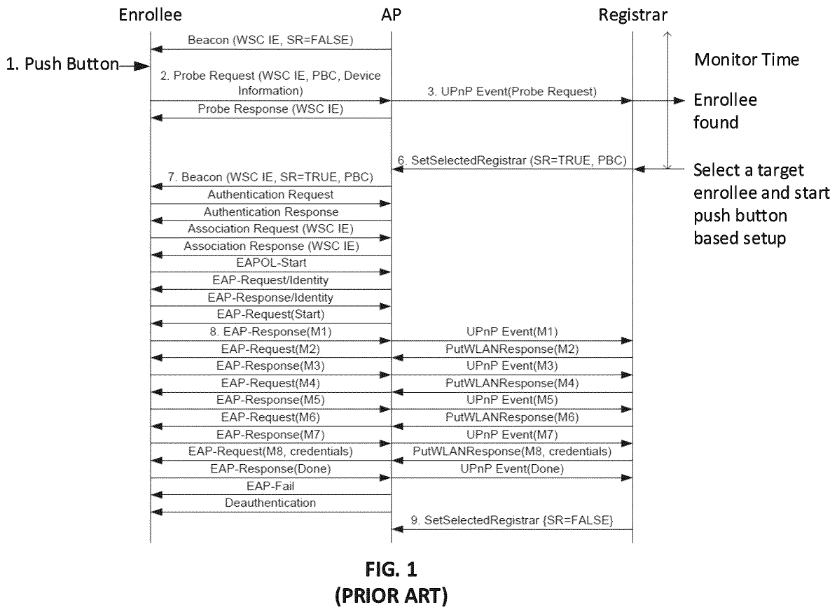

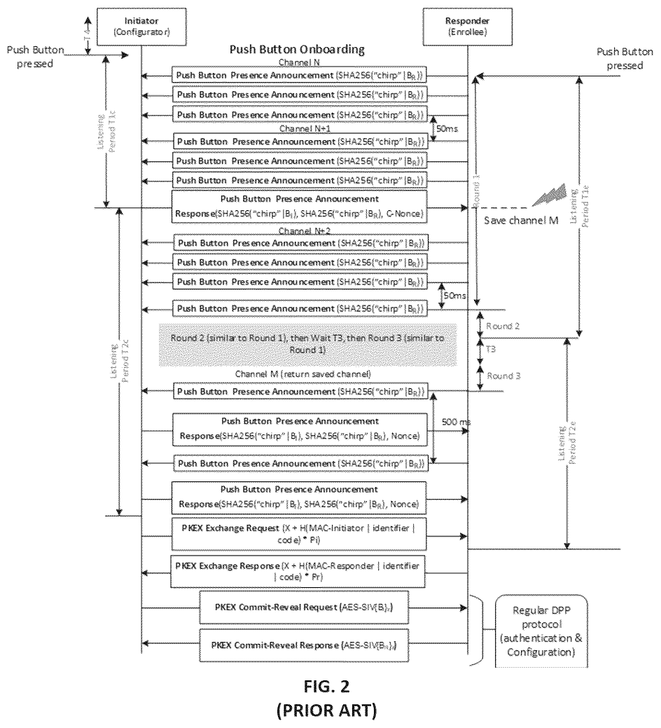

It will be noted that throughout the appended drawings, like features are identified by like reference numerals.

### DETAILED DESCRIPTION

In the context of the present disclosure, the WPS provisioning protocol and the Wi-Fi Easy Connect provisioning protocol may be referred to as connection protocols for connecting devices to an AP or to a Wi-Fi network through an AP.

Further, in the context of the present disclosure, WPA-2 Personal and WPA-3 Personal may be referred to as security protocols for securing communication between elements of a same Wi-Fi network, such as, for example, between a device and an AP.

Additionally, in the context of the present disclosure, WPS is used for connecting a device (station) to a Wi-Fi network using the WPA2-Personal protocol. Also, in the context of the present disclosure Wi-Fi Easy Connect is used for connecting a device (station) to a Wi-Fi network using the WPA3-Personal protocol.

The present disclosure provides a provisioning mechanism that enables an AP to provision a device to the AP's Wi-Fi network using either the WPA2-Personal or the WPA3-Personal security protocols. The provisioning mechanism is flexible in that it supports the connection of legacy devices operating under the WAP2-Personal security protocol and the connection of devices operating under the WPA3-Personal security protocol.

Unless defined otherwise, all technical and scientific terms used herein have the same meaning as commonly understood by one of ordinary skill in the art to which this invention belongs.

Embodiments of the present disclosure provide a mechanism that follows a typical Wi-Fi provisioning process except that, for either the push button presence announcement or the PIN presence announcement, the AP enables both WPS (for WPA2-Personal capable devices) and Wi-Fi Easy Connect (for WPA3-Personal capable devices) simultaneously.

Based on the interaction between the AP and the device (the client running on the device), the AP executes the provisioning protocol asserted by the device. In other words, depending on the messages received from the device, the AP may decide whether to use the WPS (WPA2-Personal security protocol) or the Wi-Fi Easy Connect (WPA3-Personal security protocol).

### Embodiment 1

Presently, the Wi-Fi Easy Connect provisioning protocol is configured to work out-of-band of any network operation. That is, there is no requirement for a device that wishes to connect to a Wi-Fi network using the Wi-Fi Easy Connect provisioning protocol to discover the network first.

In this embodiment of the present disclosure, the Wi-Fi Easy Connect provisioning protocol is modified for “network first” discovery, to obtain a modified Wi-Fi Easy Connect provisioning protocol that runs as follow:
A Wi-Fi network discovery process is performed at the device (at a client of the device) to identify an available Wi-Fi network.
The AP associated with the Wi-Fi network advertises that it supports Wi-Fi Easy Connect provisioning (either push button or PIN) through a WSC Information Element (IE) comprised in a Beacon Frame or in a Probe Response Frame sent from the AP to the device.
The user selects the available Wi-Fi network advertised by the AP.
The user presses a presence button on the device (in other words a button that mimics the WPS behavior) or enters a PIN to connect to the AP.
The user presses a presence button or enters a PIN on the AP to add the device to the available Wi-Fi network.
The AP and client execute the Wi-Fi Easy Connect provisioning protocol in accordance with a security protocol supported by both the device and the AP connection selection mode (push button or PKEX) to perform the provisioning (i.e., to setup the WPA2 security protocol or the WPA3 security protocol between the device and the AP).

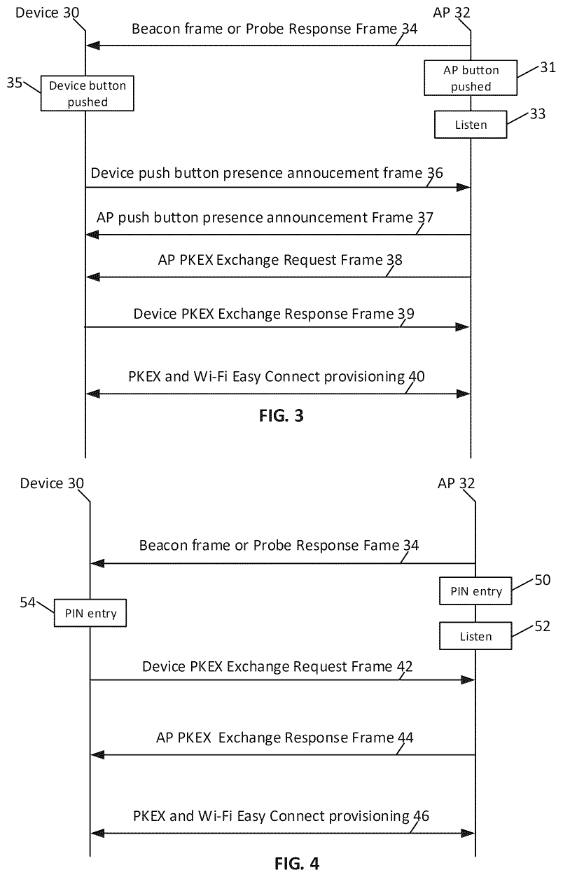

### Description of FIG. 3

FIG. 3 shows an embodiment of a process flow for provisioning a device 30 to a Wi-Fi network, through an AP 32, in accordance with the present disclosure. At action 34, the AP 32 broadcasts a Beacon Frame or a Probe Response Frame, which is structured to specify the AP 32 supports a Wi-Fi Easy Connect provisioning protocol to connect devices to the AP 32 (or to connect a device to the AP's Wi-Fi network). The Beacon Frame and the Probe Response Frame may be formed to include a WSC IE that specifies the AP supports the Wi-Fi Easy Connect provisioning protocol. The WSC IE may be formatted to include a type, a length and a value (TLV) specifying the Wi-Fi Easy Connect provisioning protocol.

When the device 30 is in a Wi-Fi network discovery mode, and, after the Beacon Frame or the Probe Response Frame is received by the device 30, the device 30 may notify the user of the device 30 that the Wi-Fi network associated with the AP 32 has been discovered and that it is configured to connect the device 30 to the AP 32 using the Wi-Fi Easy Connect provisioning protocol. Subsequently, someone (e.g., the user of the device 30) interacts with the AP 32 to cause the AP 32 to listen, at action 33, for Wi-Fi Easy Connect Presence Announcement Frames (for DPP Presence Announcement Frames). In the embodiment of FIG. 3, the interaction of the user of the device 30 with the AP 32 is a push button interaction where, at action 31, a presence button of the AP 32 is pushed.

When the user wishes to connect the device 30 to the AP 32, the user may interact with the device 30 to cause the device 30 to announce to the AP 32 the device's intention to connect to the AP 32. In the embodiment FIG. 3, the interaction of the user with the device 30 is a push button interaction where the user pushes, at action 35, a presence button on the device 30. When the presence button is pushed, the device 30 sends, at action 36, a device push button announcement to the AP. The device push button announcement may include a device Push Button Presence Announcement Frame.

The device Push Button Announcement frame received at the AP 32, triggers the AP 32 to send to the device 30, at action 37, an AP Push Button presence Announcement frame. Subsequently, the AP 32 sends, at action 38, an AP PKEX Exchange Request frame to the device 30, and, in return, the device 30 sends, at action 39, a device PKEX Exchange Response frame to the AP 32.

A difference between the prior art and embodiments of the present disclosure is that in the prior art, the device push button presence announcement frames are broadcast, and a device receiving a broadcast frame does not acknowledge receipt of the broadcast frame.

In embodiments of the present disclosure, the device discovers the AP by the AP indicating Wi-Fi Easy Connect provisioning (DPP provisioning) in Beacon frames. As such, the device push button presence announcement frame can be sent as a unicast frame, which causes the AP to acknowledge receipt of the frame. Advantageously, the AP receiving unicast frames from a device is followed by the AP sending, to the device, an acknowledgment, which results in a more robust and deterministic protocol. This is a result of the STA discovering the AP and the AP listening for Push Button Announcement frames once the push button (presence announcement button) has been pushed on the AP.

Subsequently, at action 40, the device 30 and the AP 32 proceed with the provisioning of the device 30 to the AP 32 (to the AP's Wi-Fi network) according to the PKEX and Wi-Fi Easy Connect provisioning protocols.

The device Push Button Announcement Frame and the AP Push Button Announcement Frame may each be comprised in a respective unicast message.

The Beacon Frame or Probe Response Frame, the device Push Button Announcement Frame and the AP Push Button Announcement Frame may each be transmitted between the AP 32 and the device 30 on an operating channel of the AP 32.

### Description of FIG. 4

FIG. 4 shows another embodiment of a process flow for provisioning a device 30 to a Wi-Fi network, through an AP 32, in accordance with the present disclosure. The process flow of FIG. 4 is similar to that of FIG. 3, except that in the process of FIG. 4, a PIN is entered at the AP 32 instead of an AP push button being pushed and, a PIN is entered at the device 30 instead of a device button being pushed.

Continuing with the description of FIG. 4, at action 34, the AP 32 broadcasts a Beacon Frame or a Probe Response Frame, which is structured to specify the AP 32 supports a Wi-Fi Easy Connect provisioning protocol to connect devices to the AP 32. The Beacon Frame and the Probe Response Frame may be formed to include a WSC IE that specifies the AP supports the Wi-Fi Easy Connect provisioning protocol. The WSC IE may be formatted to include a type, a length and a value (TLV) specifying the Wi-Fi Easy Connect provisioning protocol.

When the device 30 is in a Wi-Fi network discovery mode and after the Beacon Frame or the Probe Response Frame is received by the device 30, the device 30 may notify the user of the device 30 that the AP 32 has been discovered and that it is configured to connect the device 30 to the AP 32 using the Wi-Fi Easy Connect provisioning protocol. Subsequently, someone (e.g., the user of the device 30) interacts with the AP 32 to cause the AP 32 to listen, at action 52, for Wi-Fi Easy Connect PKEX Exchange Request frame. In the embodiment of FIG. 4, the interaction of the user of the device 30 with the AP 32 is a PIN-entry interaction where, at action 50, a PIN is entered at the AP 32.

When the user wishes to connect the device 30 to the AP 32, the user may interact with the device 30 to cause the device 30 to announce to the AP 32 the device's intention to connect to the AP 32. In the embodiment FIG. 4, the interaction of the user with the device 30 is PIN-entry interaction where a PIN is entered, at action 54, at the device 30. When the PIN is entered at the device 30, the device 30 sends, at action 42, a device PKEX Exchange Request Frame to the AP 32.

After having received the device push button announcement from the device 30, the AP 32 sends, at action 44, an AP PKEX Exchange Response frame to the device 30.

Subsequently, at action 46, the device 30 and the AP 32 proceed with the provisioning of the device 30 to the AP 32 (to the AP's Wi-Fi network) according to the PKEX and Wi-Fi Easy Connect provisioning.

The device PKEX Exchange Request Frame and the AP PKEX Exchange Request Frame may each be comprised in a respective unicast message.

The Beacon Frame or Probe Response Frame, the device Push Button Announcement Frame and the AP Push Button Announcement Frame may each be transmitted between the AP 32 and the device 30 on the same operating channel of the AP 32.

### Information Element

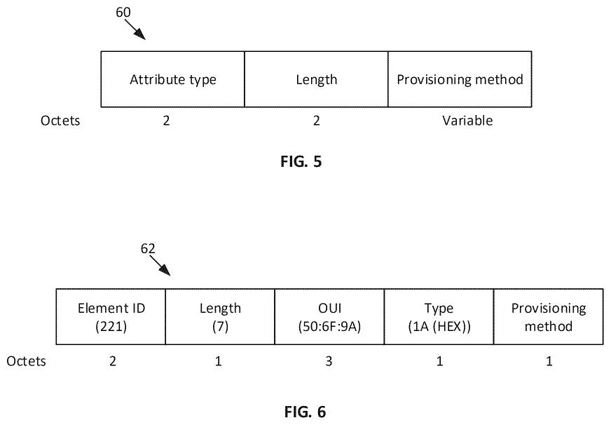

FIG. 5 shows a block diagram representation of WSC IE 60 in accordance with the present disclosure. The WSC IE 60 is formed according to the TLV format presented in Table 1. The WSC IE 60 of FIG. 5 includes multiple (in this case, three) TLV attribute fields. Each attribute is defined by type, length and data fields.

Add the WSC IE to the Wi-Fi Easy Connect configuration data:
Attribute Type=0x1065 (number to be requested from the Wi-Fi Alliance)
Length=1
Provisioning method=(0—Push Button, 1—PIN/PKEX)

### Wi-Fi Easy Connect as Separate Element

An alternative to adding a WSC IE to the Wi-Fi Easy Connect configuration data is to include a Wi-Fi Alliance vendor specific (WFAVS) IE (not a WPS element) to advertise Wi-Fi Easy Connect. FIG. 6 shows an embodiment of a WFAVS element 62 in accordance with the present disclosure.

Advantageously, Embodiment 1 allows an AP to advertise that it supports Wi-Fi Easy Connect provisioning.

### Embodiment 2

In another embodiment according to the present disclosure, an AP may offer (advertise) simultaneous support for WPS and Wi-Fi Easy Connect, which allows both legacy devices (clients) using the WPA2-Personal security protocol and new devices (new clients) that support the WPA3-Personal security protocol to be provisioned to the AP (to the Wi-Fi network to which the AP is connected).

In this embodiment, the AP may be configured to operate in a WPA3 transition mode where it advertises WPA2-Personal security protocol and the WPA3-Personal security protocol to be available on the same Wi-Fi network.

Further, in some embodiments, the AP may include a WSC IE in Beacon Frames or Probe Response frames to advertise the WPS connection option and the Wi-Fi Easy Connect connection option. In some embodiments, AP may include a WFAVS IE to advertise the WPS connection option and the Wi-Fi Easy Connect connection option.

The WPS provisioning protocol is able to provision legacy devices configured to use the WPA2-Personal security protocol but not the WPA3-Personal security protocol. The Wi-Fi Easy Connect provisioning protocol is able to provision devices that support the WPA3-Personal security protocol.

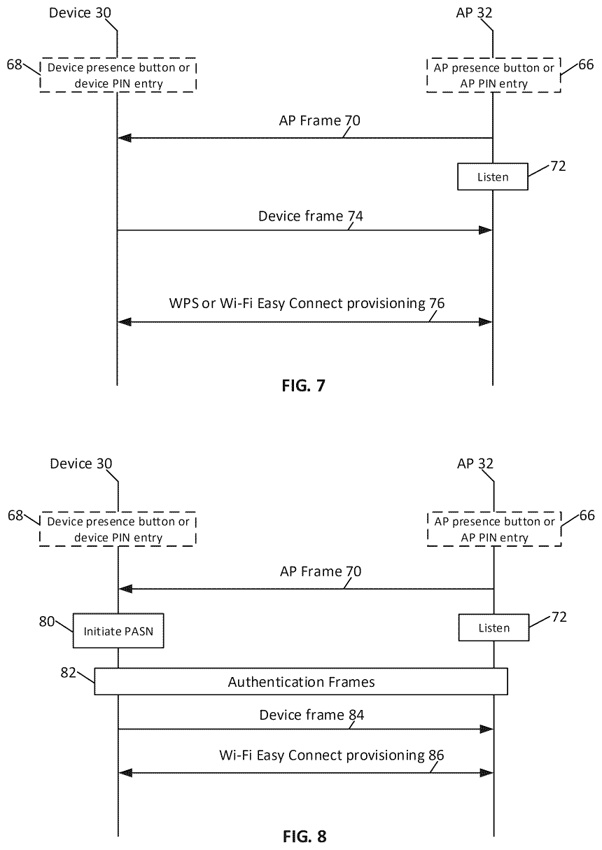

### Description of FIG. 7

FIG. 7 shows an embodiment of a process flow for provisioning a device 30 to a Wi-Fi network, through an AP 32, in accordance with the present disclosure. At action 70, after the device 30 has discovered the AP 32 and a user has pushed an AP presence push button or entered a PIN at the AP 32 (action 66) and pushed a device presence push button or entered a PIN at the device 30 (action 68), the AP 32 transmits, to the device 30, an AP Frame structured to specify to the device 30 that the AP 32 supports both the WPS provisioning protocol and the Wi-Fi Easy Connect provisioning protocol. The AP Frame may be a Beacon Frame or a Probe Response Frame.

At action 72, the AP 32 listen for reception, from the device 30, of an Association Request frame, which would indicate the device 30 supports only the WPA2-Personal security protocol and that it is to be provisioned to the AP using the WPS provisioning protocol. Simultaneously, the AP 32 listens for reception, from the device 30, of a device frame that would indicate the device 30 supports the WPA3-Personal security protocol and that it is to be provisioned to the AP 32 using the Wi-Fi Easy Connect provisioning protocol.

At action 74, the AP 32 receives a device frame, which includes an identification of the provisioning protocol to follow to provision the device 30 to the AP 32. At action 76, the device 30 is provisioned to the AP 32 according to the WPS provisioning protocol or the Wi-Fi Easy Connect provisioning protocol, depending on the content of the device frame, i.e., depending on the provisioning method indicated in the device frame.

### Push Button Presence Announcement Frame and WPA3-Personal Device

When the AP Frame transmitted at action 70 follows the AP presence button having been pushed at action 66 and the device presence button having been pushed at action 68, then the AP Frame indicates, to the device 30, that a response from the device 30 may need to take into consideration the aforementioned push button actions. In particular, the device 30 will take into consideration the aforementioned push button actions when the device 30 supports the WPA3-Personal security protocol and will proceed to connect to the AP 32 using the Wi-Fi Easy Connect provisioning protocol. In this scenario, the device 30 transmits (sends), to the AP 32, at action 74, the device frame, which is, in this scenario, a Push Button presence announcement frame. The Push Button presence announcement frame indicates the provisioning of the device 30 to the AP 32 (to the Wi-Fi network to which the AP 32 is connected) is to be carried out according to the Wi-Fi Easy Connect provisioning protocol for push button announcement.

At action 76, when the device frame is a Push Button Presence Announcement frame, the AP 32 and the device 30 follow the Wi-Fi Easy Connect provisioning protocol to provision the device 30 to the AP 32, considering the WPA3-Personal security protocol.

### PKEX Exchange Request Frame and WPA3-Personal Device

When the AP Frame transmitted at action 70 follows an AP PIN entry at action 66 and a device PIN entry at action 68, then the AP Frame indicates, to the device 30, that a response from the device 30 may need to take into consideration the aforementioned PIN entries. In particular, the device 30 will take into consideration the PIN entry actions when the device 30 supports the WPA3-Personal security protocol and is to connect to the AP 32 using the Wi-Fi Easy Connect provisioning protocol. In this scenario, the device 30 transmits (sends) to the AP 32, at action 74, a device frame that is a PKEX Exchange Request Frame which indicates the provisioning of the device 30 to the AP 32 (to the Wi-Fi network to which the AP 32 is connected) is to be carried out according to the Wi-Fi Easy Connect provisioning protocol for PKEX exchange.

At action 76, when the device frame is a PKEX Exchange Request Frame, the AP 32 and the device 30 follow the Wi-Fi Easy Connect provisioning protocol to provision the device 30 to the AP 32, considering the WPA3-Personal security protocol.

### Device Supports WPA2-Personal but not WPA3-Personal

When the device supports the WPA2-Personal security protocol but not the WPA3-Personal security protocol, the device frame sent by the device 30 at action 74 will be a WPS Association Request frame, regardless of whether presence buttons were pushed or PINs entered at action 66 and action 68.

At action 76, when the device frame is a WPS Association Request frame, the AP 32 and the device 30 follow the WPS provisioning protocol to provision the device 30 to the AP 32, considering the WPA2-Personal security protocol.

Advantageously, Embodiment 2 allows an AP to advertise that it supports both WPS and Wi-Fi Easy Connect provisioning. Depending on the type of message received from a device, when a button is pushed (or PIN entered), the AP can then decide to continue with either WPS or Wi-Fi Easy Connect.

### Embodiment 3

In another embodiment, additional security may be added to the Wi-Fi Easy Connect PIN case or push button case (without changing any other behavior) by allowing the device to perform PASN (Pre-Association Security Negotiation) prior to the Wi-Fi Easy Connect exchanges. This allows the device and AP to protect the Push Button Presence Announcement frames or the PKEX Exchange request frames in accordance with the PASN process.

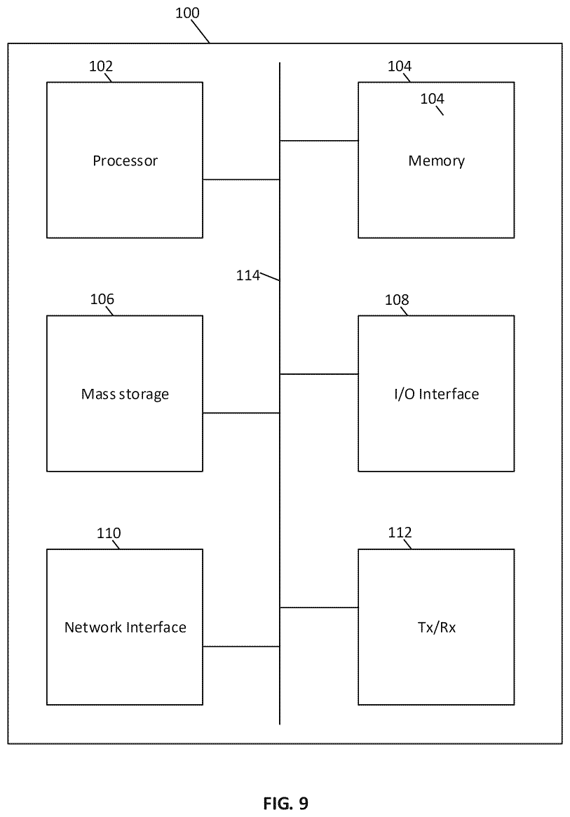

FIG. 8 shows an embodiment of a process flow for provisioning a device 30 to a Wi-Fi network, through an AP 32, in accordance with the present disclosure. The embodiment shown at FIG. 8 shows actions similar to those shown in the embodiment of FIG. 7. However, in the embodiment of FIG. 8, the device 30 initiates a PASN process to secure device frames sent to the AP 32 by the device 30.

PASN negotiation is initiated, at action 80, by the device 30, after a button push or PIN entry on the device and after receiving the AP frame sent by the AP 32 at action 70. PASN authentication frames are passed, at action 82, between the device 30 and the AP 32. A device frame, which is secured in view of the PASN process, is received by the AP 32 at action 84. Wi-Fi Easy Connect provisioning of the device 30 to the AP 32 is carried out at action 86. The PASN protocol is described in Clause 12.12 of the document: P802.11az™/D7.0 Draft Standard for Information technology—Telecommunications and information exchange between systems Local and metropolitan area networks—Specific requirements.

Advantageously, Embodiment 3 allows the Wi-Fi Easy Connect provisioning exchanges to be protected with additional security provided by PASN.

FIG. 9 shows a block diagram of an embodiment of an electronic device 100 for provisioning devices to a Wi-Fi network to which the apparatus is connected, in accordance with the present disclosure. The apparatus 100 may perform any or all of actions of the methods described above, in accordance with embodiments of the present disclosure. In some embodiments, the electronic device 100 may be the AP described elsewhere in the present disclosure.

The electronic device includes a processor 102, such as a Central Processing Unit (CPU) or specialized processors such as a Graphics Processing Unit (GPU) or other such processor unit, a memory 104, a tangible, non-transitory processor-readable memory (storage) 106, an I/O interface 108, a network interface 110, and a transceiver 112, all of which are communicatively coupled via bi-directional bus 114. According to certain embodiments, any or all of the depicted elements may be utilized, or only a subset of the elements. Further, the electronic device 100 may contain multiple instances of certain elements, such as multiple processors, memories, or transceivers. Also, elements of the electronic device may be directly coupled to other elements without the bi-directional bus. Additionally, or alternatively to a processor and memory, other electronics, such as integrated circuits, may be employed for performing the required logical operations.

The memory 104 may include any type of non-transitory memory such as static random access memory (SRAM), dynamic random access memory (DRAM), synchronous DRAM (SDRAM), read-only memory (ROM), any combination of such, or the like. The a tangible, non-transitory processor-readable memory (storage) 106 may include any type of non-transitory storage device, such as a solid state drive, hard disk drive, a magnetic disk drive, an optical disk drive, USB drive, or any computer program product configured to store data and machine executable program code. According to certain embodiments, the memory 104 or the tangible, non-transitory processor-readable memory (storage) 106 may have recorded thereon statements and instructions executable by the processor 102 for performing any of the aforementioned actions described above in relation to the methods of the present disclosure.

Through the descriptions of the preceding embodiments, the present invention may be implemented by using hardware only or by using software and a necessary universal hardware platform. Based on such understandings, the technical solution of the present invention may be embodied in the form of a software product. The software product may be stored in a non-volatile or non-transitory storage medium, which can be a compact disk read-only memory (CD-ROM), USB flash disk, or a removable hard disk. The software product includes a number of instructions that enable a computer device (personal computer, server, or network device) to execute the methods provided in the embodiments of the present invention. For example, such an execution may correspond to a simulation of the logical operations as described herein. The software product may additionally or alternatively include number of instructions that enable a computer device to execute operations for configuring or programming a digital logic apparatus in accordance with embodiments of the present invention.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

We claim:

1. A method, comprising:
by an access point (AP) of a Wi-Fi network:
broadcasting a first AP frame structured to specify that the AP supports a Wi-Fi Easy Connect provisioning protocol to connect a device to the AP;
receiving, from a device that received the first AP frame, a device frame structured to indicate that the device wishes to connect to the AP;
in response to having received the device frame, sending, to the device, a second AP frame structured to indicate that the AP will allow the device to connect to the AP; and
interacting with the device to connect the device to the AP using the Wi-Fi Easy connect provisioning protocol.

2. The method of claim 1, wherein:
the device frame is a unicast device push button announcement frame,
the second AP frame is a unicast AP push button announcement frame, and
interacting with the device to connect the device to the AP using the Wi-Fi Easy connect provisioning protocol includes, by the AP:
sending to the device, a unicast AP PKEX Exchange Request frame; and
receiving, from the device, a unicast device PKEX Exchange Request frame.

3. The method of claim 1, wherein the first AP frame is a Beacon frame or a Probe Response frame.

4. The method of claim 1, wherein the device frame is a device push button presence announcement frame.

5. The method of claim 4, wherein the second AP frame is an AP push button presence announcement frame.

6. The method of claim 1, wherein the device frame is a device Public Key Exchange (PKEX) Request frame.

7. The method of claim 6, wherein the second AP frame is an AP PKEX Response frame.

8. The method of claim 1, wherein the first AP frame includes at least one of:
a Wi-Fi Simple Configuration (WSC) information element (IE) that specifies that the AP supports the Wi-Fi Easy Connect provisioning protocol to connect the device to the AP; and
a Wi-Fi Easy Connect information element (IE), distinct from any Wi-Fi Simple Configuration (WSC) information element (IE), that specifies that the AP supports the Wi-Fi Easy Connect provisioning protocol to connect the device to the AP.

9. The method of claim 8, wherein the WSC IE includes an attribute that has a type field, a length field and a provisioning method field that specify if the Wi-Fi Easy Connect provisioning protocol follows a push button method or a PIN/PKEX method, the provisioning method field having a value that is equal to either one or zero, the value zero to indicate one of the push-button method and the PIN/PKEX method, the value one to indicate the other of the push-button method and the PIN/PKEX method.

10. A method, comprising:
by an access point (AP) of a Wi-Fi network:
broadcasting an AP frame structured to specify that the AP supports a Wi-Fi Protect Setup (WPS) provisioning protocol and a Wi-Fi Easy Connect provisioning protocol to connect a device to the AP;
receiving, from a device that received the first AP frame, one of:
a device frame structured to indicate that the device selects the WPS provisioning protocol to connect to the AP; and
a device frame structured to indicate that the device selects the Wi-Fi Easy Connect provisioning protocol to connect to the AP.

11. The method of claim 10, wherein the WPS provisioning protocol is for selection by devices configured to support a single security protocol, the single security protocol being a WPA2-Personal security protocol.

12. The method of claim 10, wherein the Wi-Fi Easy Connect provisioning protocol is for selection by devices configured to support a WPA3-Personal security protocol.

13. The method of claim 10, wherein the AP frame is a Beacon frame or a Probe Response frame.

14. The method of claim 10, wherein the AP frame includes at least one of:
a Wi-Fi Simple Connection (WSC) information element (IE) that specifies that the AP supports the WPS provisioning protocol and the Wi-Fi Easy Connect provisioning protocol to connect the device to the AP; and
a Wi-Fi Alliance vendor specific (WFAVS) IE that specifies the AP supports the WPS provisioning protocol and the Wi-Fi Easy Connect provisioning protocol to connect the device to the AP.

15. The method of claim 10, wherein:
the device frame structured to indicate that the device selects the WPS provisioning protocol to connect to the AP is an Association Request frame; and
the device frame structured to indicate that the device selects the Wi-Fi Easy Connect provisioning protocol to connect to the AP is one of a Push Button Announcement frame and a PKEX Request frame.

16. The method of claim 15, the method further comprising, by the AP:
Generating the AP frame in accordance with a Push Button signal generated by the AP, the AP frame configured to indicate that the AP frame was generated in accordance with the Push Button signal;
simultaneously listening for reception, from the device that received the AP frame, of one of:
the Association Request frame; or
the Push Button Announcement frame; and
receiving from the device that received the AP frame, one of the Association Request frame and the Push Button Announcement frame.

17. The method of claim 16, wherein, when the AP receives the Association Request frame, the method further comprises, by the AP:
ending listening for reception, from the device that received the AP frame, of the Association Request frame or the Push Button Announcement frame; and
provisioning the device to the AP in accordance with the WPS provisioning protocol and the WPA2-Personal security protocol.

18. The method of claim 16, wherein, when the AP receives the Push Button Announcement frame, the method further comprises, by the AP:
ending listening for reception, from the device that received the AP frame, of the Association Request frame or the Push Button Announcement frame; and
provisioning the device to the AP in accordance with the Wi-Fi Easy Connect provisioning protocol and the WPA3-Personal security protocol.

19. The method of claim 15, the method further comprising, by the AP:
generating the AP frame in accordance with a PIN entry signal generated by the AP, the AP frame configured to indicate that the AP frame was generated in accordance with the PIN entry signal;
listening for reception, from the device that received the AP frame, of one of:
the Association Request frame; or
the PKEX Request frame; and
receiving from the device that received the AP frame, one of the Association Request frame and the PKEX Exchange Request frame.

20. The method of claim 19, wherein, when the AP receives the Association Request frame, the method further comprises, by the AP:
ending listening for reception, from the device that received the AP frame, of the Association Request frame or the PKEX Exchange Request frame;
proceeding to provision the device to the AP in accordance with WPS provisioning protocol and the WPA2-Personal security protocol.

21. The method of claim 19, wherein, when the AP receives the PKEX Exchange Request frame, the method further comprises, by the AP:
ending listening for reception, from the device that received the AP frame, of the Association Request frame or the PKEX Exchange Request frame;
proceeding to provision the device to the AP in accordance with the Wi-Fi Easy Connect provisioning protocol and the WPA3-Personal security protocol.

22. A method, comprising:
by a device:
receiving, from an access point AP, an announcement indicating that the AP supports a Wi-Fi Protect Setup (WPS) provisioning protocol and a Wi-Fi Easy Connect provisioning protocol to connect the device to the AP;
when the device is configured to support the WPA3-Personal security protocol:
selecting the Wi-Fi Easy Connect provisioning protocol;
when the device is configured to support the WPA2-Personal security protocol but not the Wi-Fi Easy Connect provisioning protocol, selecting the WPS provisioning protocol.
